(19) United States
(12) Patent Application Publication
(10) Pub. No.: US 2006/0150504 A1
(43) Pub. Date: Jul. 13, 2006

(54) Method for packing and planting young plants

(76) Inventors: Timothy L. Kosderka, Roseburg, OR (US); Douglas Schlatter, Roseburg, OR (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/058,148

(22) Filed: Feb. 14, 2005

Related U.S. Application Data
(60) Provisional application No. 60/640,006, filed on Dec. 28, 2004.

(51) Int. Cl. A01G 23/02; A01G 9/02

(52) U.S. Cl. 47/73

(57) ABSTRACT

A method for packing and planting young plants is provided. The method comprises placing young plants, such as tree seedlings, in a container wherein the container is later planted with the young plant. The containers protect the young plants from wildlife browsing. The containers are packed in packaging which may be adaptable for use in a planter bag.

### CROSS REFERENCE TO RELATED APPLICATION

The present application claims the benefit of U.S. Provisional Application No. 60/640,006, filed Dec. 28, 2004.

### FIELD OF THE INVENTION

The present invention relates to a method for packaging, transporting and planting young plants.

### BACKGROUND OF THE INVENTION

Wildlife, such as deer, elk, rabbits, are inclined to nibble and eat young plants. This can reduce the seasonal plant growth. Depending upon the extent of damage, the plants' ability to produce food may be lessened. This may result in less ability of the plant to survive later stresses, such as sudden and severe changes in the weather.

Wildlife can also uproot young plants. If these plants are tree seedlings, this may result in the need for replanting to achieve reforestation. If these plants are crops, such as berry or grape vines, this may result in the need for new planting to achieve the anticipated crop production.

### SUMMARY OF THE INVENTION

The present invention provides a method for packing, transporting and planting young plants, such as vines or tree seedlings. The method comprises the use of containers having flexible sidewalls which define an opening at either end.

According to the method, young plants are packed within the containers and transported and planted in the containers. The containers filled with the young plants are in packaging, such as a box or box liner disposed within a box. In one form of the invention, the container comprises a flexible and biodegradable or photodegradable material, such as Vexar® tubing. The packaging, such as the box or the box liner, may be adaptable for use in a planter bag.

The method of the present invention comprises placing a container in packaging, such as a box or box liner disposed in a box. The method also comprises placing a young plant in a container. The young plant may be placed in the container either before or after the container is placed in the packaging. The packaging may be used to transport the plants to a location for outplanting. The young plant and container are planted as a unit, with a portion of the container extending over the shoot end of the young plant to protect it from wildlife. The packaging may be adapted and for placed in a planter bag such that the containers filled with the young plants do not need to be individually handled between the initial placing of the young plants in the containers and the final planting of the young plants and containers in soil.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows components for use in packing young plants;

FIG. 2 shows components for use in planting young plants; and

FIG. 3 shows components which are planted with a young plant.

### DETAILED DESCRIPTION OF THE INVENTION

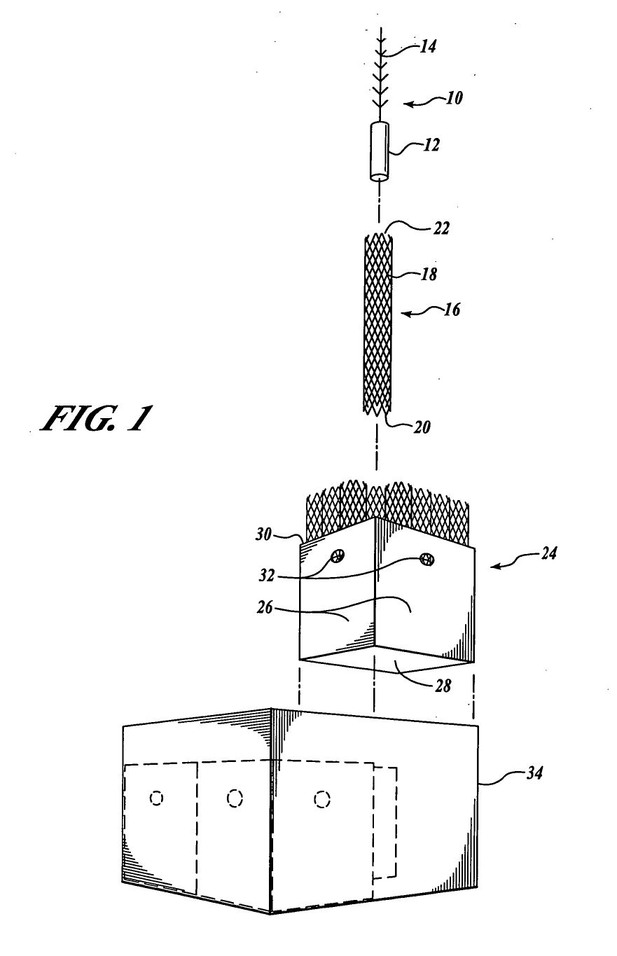

Referring to FIG. 1, the present invention provides a method for packing and planting a young plant 10, having a root end 12 and a shoot end 14. These plants may be young tree seedlings, vines, shrubbery or other foliage.

Young plants are placed in a container 16 having at least one sidewall 18 forming an open end 20 on one end and open end 22 on the other end. At least one open end is sized for receiving the young plant 10. The sidewall 18 is sized for extending over the substantially all of the root end 12 of a young plant 10 and for covering the shoot end 14. The sidewall 18 may extend substantially beyond the shoot end 14.

The method includes packaging, such as a bag, box or a box and a box liner 24. A box liner 24 may have side panels 26 and bottom panel 28 and an open end 30. The side panels 26 may include apertures 32. The box liner 24 is sized for receiving multiple containers 16. In one embodiment of the invention, the box liner 24 is sized to fit in a planting bag 38. The box liner 24 is sized to fit into box 34. In one embodiment of the invention, box 34 is sized for receiving multiple box liners 24. The box liner 24 or the box 34 may include moisture control, such as a wax coating.

In an alternate form of the invention, the box liner 24 may be eliminated and the containers 16 placed directly in packaging such as box 34. The box 34 may be adaptable for being received in a planting bag 38.

The container 16 may comprise a variety of materials. In one embodiment of the invention, the container 16 has sidewalls 18 flexible enough to allow the container and plant 10 to be grasped and planted as a unit yet the container has stability to remain substantially upright around the plant 10 when planted in soil 36. The container may be biodegradable in the field over a period of a few years. A portion of the container 16 may include light-emitting sidewall 18 which in use surround the shoot end 14 of the plant 10 and allow sunlight to reach the shoot end 14 of the plant 10. Suitable materials for including in the container include biodegradable or photodegradable netting or mesh, such as Vexar® plastic netting produced by the E.I. du Pont de Nemours and Company of Wilmington, Del.

In one embodiment of the invention, the plant 10 is a containerized plant, plug seedling or a plant grown in a container. The plant growing container used to grow the plant may be shaped to provide a root end 12 of a plant 10 which is easily inserted into container 16. In another embodiment of the invention, the plant is grown in a planting tray. The planting tray may have individual planting compartments shaped for producing a young plant with a root end 12 sized and shaped to be placed in a container 16. Upon extracting a young plant 10 from a planting tray, the plant 10 is placed into a container 16. The young plant 10 may be placed into the container 16 prior to placing the container 16 in the packaging, such as box liner 24 or after the container 16 has been placed in the packaging, such as box liner 24.

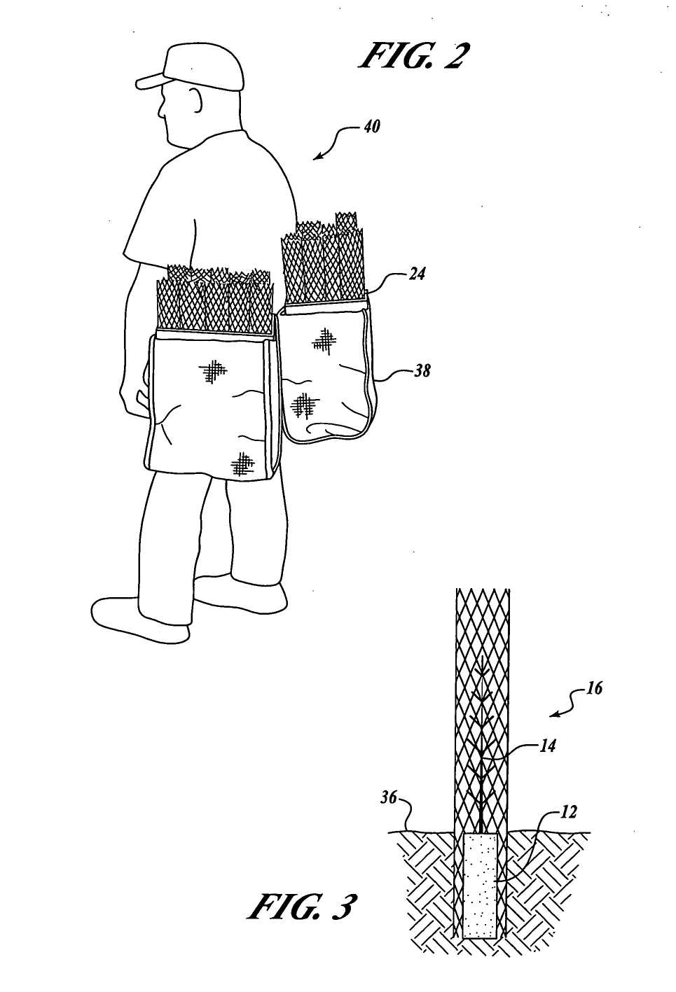

As shown in FIG. 1, in one embodiment of the invention, the containers 16 are placed in the box liner 24 so that the bottom end 20 of the container 16 is against bottom panel 28 and the sidewalls 18 of the container 16 are parallel to the side panels 26. In this configuration, the containers 16 can be placed in the box liner 24 and a young plant 10 slid through the top open end 22 of each container 16. Box 34 is sized to receive multiple box liners 24. Once each box liner 24 has been filled, the box is closed and transported to a location for outplanting. For planting, a filled box liner 24 is removed from box 34 and placed in a planter bag 38, as shown in FIG. 2.

During planting, the container 16 and plant 10 are removed from the box liner 24. The sidewall 18 of the container 16 is flexible so as to allow the container 16 and plant 10 to be removed as a unit from the box liner 24. The container 16 and plant 10 are then planted in soil 36, as sown in FIG. 3. When planted, a portion of sidewall 18 of the container 16 is planted in the soil 36. The other portion of the sidewall 18 extends above the soil 36 and surrounds the shoot end 14 of the plant 10. After planting, the container 16 prevents wild game from uprooting, grazing, browsing or otherwise damaging the plant 10.

Referring to FIGS. 1, 2 and 3, in one embodiment of the invention the young plants 10 are tree seedlings, such as Douglas Fir or Loblolly pine containerized seedlings grown in styro block planting containers. A box 34 is sized to receive four box liners 24. The box liners 24 are placed in the box 34. The box liners 24 are sized to receive about twenty containers 16. Containers 16 in the form of Vexar® tubing are placed in the box liners 24. Containerized seedlings are extracted from growing containers and slid into the containers 16. When placed in the container 16 in the box liner 24, the root end 12 of the plant 10 is approximately flush with the bottom open end 20 of the container 16 and the root end 12 rests on the bottom panel 28 of the box liner 24. The shoot end 14 of the plant 10 extends to within approximately two to four inches below the top open end 22 of the container 16. Once full, the box 34 is closed and transported to the field for planting. During shipment, the containers 16 protect the young plants 10 from damage, such as by preventing the young plants 10 from becoming entangled with each other. In the field, the box 34 is opened and box liners 24 lifted out and placed into planting bags 38.

In the field, the planter 40 grasps a container 16 about four to six inches below the top open end 22 of the container, so that the shoot end 14 of the plant is also held. The planter 40 places the container 16 containing the plant 10 in the soil 36, with the top of the root end 12 is about one inch below the top level of the soil 36. After planting, the container 16 helps prevent wild life from grazing or browsing on the plant 10 and damaging the needles or buds.

While the different embodiment of the invention has been illustrated and described, it will be appreciated that various changes can be made therein without departing from the spirit and scope of the invention.

The embodiments of the invention in which an exclusive property or privilege is claimed are defined as follows:

1. A method for packing and planting a young plant, comprising:
placing a container in packaging, said container comprising a sidewall forming a top open end and a bottom open end;
placing a young plant in the container;
removing the young plant and container from the packaging as a unit; and
planting the young plant and the container as a unit such that at least a portion of the container protects the young plant from browsing and grazing by wildlife.

2. The method of claim 1 wherein the packaging comprises a box liner which is placed in a box for packing.

3. The method of claim 1 wherein the packaging, container and young plant are transported prior to planting the young plant and container as a unit.

4. The method of claim 2 wherein the box liner is placed in a planter bag prior to planting the young plant and container as a unit.

5. The method of claim 2, wherein the box liner is placed in the box and the container is placed in the box liner prior to the young plant being placed in the container.

6. The method of claim 1, wherein the packaging is filled with multiple containers prior to each container being filled with a young plant.

7. The method of claim 1 wherein the packaging comprises a box and the method include transporting the container and young plant in the box and the box is adapted for placement in a planter bag prior to planting the young plant and container as a unit.

8. A method for packing and planting a young plant, comprising:
placing a young plant in a container, said container comprising a sidewall forming a top open end and a bottom open end;
placing the container in packaging;
removing the young plant and container from the packaging as a unit; and
planting the young plant and the container as a unit such that at least a portion of the container protects the young plant from browsing and grazing by wildlife.

9. The method of claim 8 wherein the packaging comprises a box liner which is placed in a box for packing.

10. The method of claim 8 wherein the packaging, container and young plant are transported prior to planting the young plant and container as a unit.

11. The method of claim 9 wherein the box liner is placed in a planter bag prior to planting the young plant and container as a unit.

12. The method of claim 8 wherein the packaging comprises a box and the method include transporting the container and young plant in the box and the box is adapted for placement in a planter bag prior to planting the young plant and container as a unit.
